(19) United States
(12) Patent Application Publication
(10) Pub. No.: US 2006/0156341 A1
(43) Pub. Date: Jul. 13, 2006

(54) Apparatus for generating a virtual channel and operating method thereof for improved digital television (DTV) viewing

(75) Inventor: Beom-eun Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Elecronics Co., Ltd.

(21) Appl. No.: 11/320,728

(22) Filed: Dec. 30, 2005

(30) Foreign Application Priority Data
Jan. 10, 2005 (KR) 2005-2175

(51) Int. Cl. H04N 5/445; G06F 3/00; G06F 13/00; H04N 7/173; H04N 7/16

(52) U.S. Cl. 725/48; 725/118; 725/30

(57) ABSTRACT

An apparatus for generating a virtual channel and a method of operating the generated virtual channel are provided. The apparatus for generating the virtual channel comprises a virtual channel setting module for setting any one channel among a plurality of channels to be a virtual channel per user; and a virtual channel processing module for registering the program selected by the user who has set the virtual channel in a program list associated with the virtual channel. The virtual channel can be set per user so that a program suiting to each user's taste can be watched even when several users use the same TV.

### CROSS-REFERENCE TO RELATED APPLICATION

This application claims benefit under 35 U.S.C. §119(a) from Korean Patent Application No. 2005-2175 filed on Jan. 10, 2005 in the Korean Intellectual Property Office, the entire contents of which are incorporated herein by reference.

### BACKGROUND OF THE INVENTION

1. Field of the Invention

The present invention relates to an apparatus of generating a virtual channel and a method of operating the virtual channel, which allows an individual virtual channel to be set per user so that several users sharing a TV can watch a program suiting to their tastes.

2. Description of the Related Art

Most people spend a significant amount of time watching television (TV) each day, and seek to find new pleasures or information from the TV. Presently, with the availability of digital broadcasts, as well as cable broadcasts, selecting broadcasts and programs based on several channels and information suited to one's taste to watch on TV on a given day is extremely cumbersome to viewers. Surfing channels by pressing buttons of a TV remote control tens to hundreds of times in a day to find a desired broadcast often causes viewers irritation.

Further, watching TV programs overlapping one another in broadcast times makes viewers feel more irritated when they need to make a selection. Viewers typically have favorite programs so that there are various viewers including those who watch sports, those who watch soap operas, those who watch current affair programs, and so forth. Taking a careful look at viewers' tastes, it can be seen that a TV program pattern is set per viewer. The TV program pattern is almost set per day from Monday to Sunday and per times suiting each viewer; however, the viewer often tries to find all broadcasts for his programs only. As such, very simple functions have been implemented in the related art which use a remote control or selection buttons built into the TV to search a desired channel, timer-record the TV program to watch by setting a timer to record and discontinue recording at the desired times, or turn on/off the TV. Conventional and similar functions in the TV are cumbersome to users because they need to manually input each of the functions using the timer or the remote control.

To cope with such problems, an apparatus of generating a virtual channel and a method using the same (Korean Patent Application No. 10-2002-0035139) has been already filed by the present applicant which allows the TV to continuously and positively schedule and control the program in an any virtual channel without any specific setting of the user by extracting the TV watching program pattern from the user and making into an information table.

However, the above-described application has a drawback in that there is no clear reference to whose favorite information must be referred to among several users when they watch the TV at the same time. That is, when several users use the TV at the same time, the favorite information of the users becomes ambiguous so that the tastes of the users cannot be properly recognized.

### SUMMARY OF THE INVENTION

It is therefore an object of the present invention to provide an apparatus for generating a virtual channel, and a method of operating the generated virtual channel, which allow an individual virtual channel to be set through a login and password registration per user so that several users sharing a TV can watch a program suited to their respective tastes with minimal manual input required via a remote control or built-in TV selection buttons.

According to an exemplary aspect of the present invention, there is provided an apparatus for generating a virtual channel from a satellite broadcast signal, a cable broadcast signal, or a ground wave broadcast signal received via an antenna or a cable network, which comprises: a virtual channel setting module for setting any one channel among several channels as a virtual channel per user; and a virtual channel processing module for generating at least one program list for a virtual channel comprising predetermined programs selected by the user who has set the virtual channel and registered in the program list on the virtual channel.

Preferably, a base channel can be set per user for viewing on the virtual channel when no other programs are selected by the user.

In accordance with another aspect of the present invention, the virtual channel processing module preferably determines whether broadcast times of the programs selected by the user overlap broadcast times of the programs already registered on the virtual channel, and notifies the user to select one program among the programs registered on the virtual channel to view during the respective overlapping broadcast times.

The apparatus preferably further comprises a database for storing information corresponding to the program registered on the virtual channel.

The period for storing the program information in the database is predetermined and preferably about one week.

The program information preferably comprises a broadcast time, a broadcast date, and a title of the program.

The virtual channel processing module preferably retrieves from a broadcast program organization table program information relating to a selected program by its program title, and preferably controls the selected program to broadcast via the virtual channel on the date and time of broadcast indicated via the retrieved program information.

The virtual channel processing module preferably performs a user initial setting on the virtual channel when a virtual channel number, a virtual channel title, a login icon, and a password are newly registered by the user in a predetermined user registration menu.

The virtual channel processing module preferably automatically removes the program in the program list on the virtual channel when a broadcast period of the program registered on the virtual channel is terminated.

The virtual channel processing module preferably updates the program information corresponding to a program stored in the database with a changed time when the broadcast time of the program registered on the virtual channel is changed.

Furthermore, the apparatus preferably comprises a user interface for displaying the virtual channel set per user on a User Interface (US) screen.

Furthermore, the apparatus preferably comprises a key input module having a button (e.g., ‘favorite program registration button’) as a shortcut button for registering a program on the virtual channel.

According to another exemplary aspect of the present invention, there is provided a method of operating a virtual channel, which comprises: determining whether a user initial setting for the virtual channel is present; performing authentication on a user trying to use the virtual channel when the user initial setting for the virtual channel is present; determining that the user has logged in and setting the virtual channel per user when the authentication for the user is successful; and registering a predetermined program selected by the user on the virtual channel.

According to another exemplary aspect of the present invention, the method further comprises the steps of determining whether broadcast times of the programs selected by the user overlap broadcast times of the programs already registered on the virtual channel, and notifying the user to select one program among the programs registered on the virtual channel to view via the virtual channel when the broadcast times overlap one another.

Information corresponding to the program registered on the virtual channel is preferably stored in a database when the program selected by the user is registered on the virtual channel.

The program information preferably comprises a broadcast time, a broadcast date, and a title of the program.

According to another exemplary aspect of the present invention, the method further comprises the steps of retrieving from a broadcast program organization table program information relating to a selected program, which is preferably retrieved by the program title, and controlling the selected program to be broadcast via the virtual channel on the date and time of broadcast indicated via the retrieved program information.

A user initial setting on the virtual channel is preferably completed when a virtual channel number, a virtual channel title, a login icon, and a password are newly registered by the user in a predetermined user registration menu.

A program is preferably automatically removed from the program list on the virtual channel when a broadcast period of the program registered on the virtual channel is terminated.

According to another exemplary aspect of the present invention, the method further comprises the steps of updating program information with a changed time when the broadcast time of the program registered on the virtual channel is changed.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating an apparatus for generating a virtual channel and a TV watching device having the same in accordance with an exemplary embodiment of the present invention;

FIG. 2 is a flow chart provided for explaining a method of operating a virtual channel in accordance with an exemplary embodiment of the present invention; and

FIG. 3 is a view illustrating a login screen in accordance with an exemplary embodiment of the present invention.

### DETAILED DESCRIPTION OF THE PREFERRED EMBODIMENTS

Hereinafter, the present invention will be described in detail with reference to accompanying drawings. Throughout the drawings, the same or similar elements are denoted by the same reference numerals. In the following description, a detailed description of known functions and configurations incorporated herein has been omitted for conciseness.

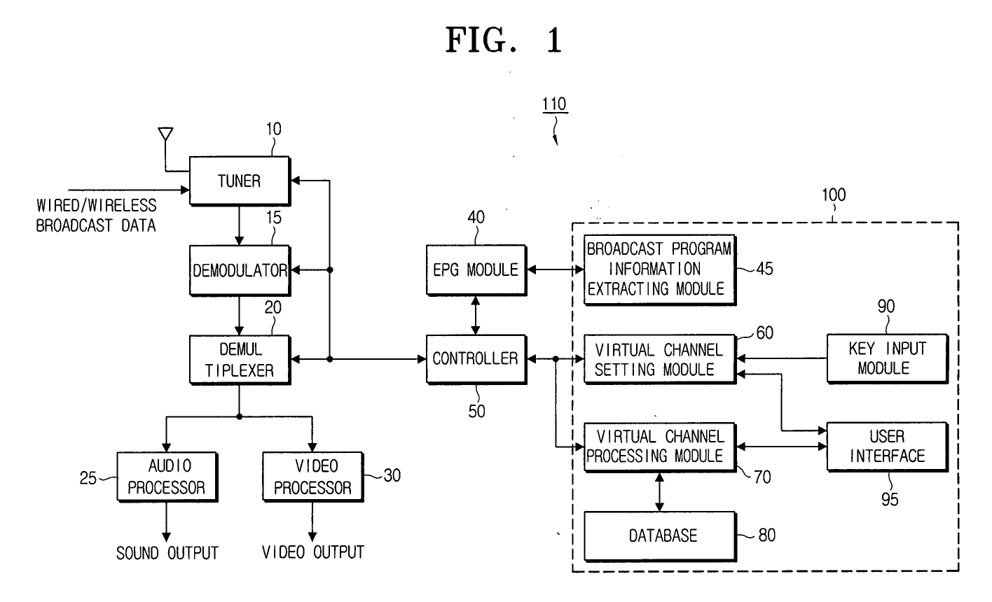

FIG. 1 is a block diagram illustrating an apparatus 100 for generating a virtual channel and a TV watching device 110 having the same in accordance with an exemplary embodiment of the present invention. Referring to FIG. 1, a broadcast signal (e.g., a digital broadcast signal) received via an antenna or a cable network is selected by a controller 50 via a tuner 10. The broadcast signal selected by the controller 50 is output in a digital packet form by a demodulator 15, which is output as audio and video streams through demultiplexing by a demultiplexer 20. An audio processor 25 performs signal processing on the audio stream to output sounds, and a video processor 30 performs signal processing on the video streams to output videos.

An Electronic Program Guide (EPG) module 40 stores EPG data transmitted from each broadcast station, and updates the EPG data. A broadcast program information extracting module 45 extracts broadcast information selected by the current TV viewer from the received broadcast information. The selected broadcast information is extracted based on the EPG data.

A virtual channel setting module 60 controls the demultiplexer 20 to assign the virtual channel set per user to an unused channel. In addition, it allows a login icon and a password to be set to perform authentication on the user who has set the virtual channel. The virtual channel setting module 60 itself preferably comprises a memory for storing the virtual channel set by the user, the login icon, the password, and so forth. It is to be understood, however, that a separate memory in the apparatus 100 or the TV watching device 110 can be used.

A key input module 90 comprises several buttons (e.g., numerical buttons, menu buttons, function buttons or the like) and, in particular comprises a ‘favorite program registration button’ which is a shortcut button used to select the broadcast program to be registered in the virtual channel set by the user.

A database 80 stores information of the broadcast program selected by the user, that is, a broadcast time, a broadcast date, a program title, of the program and so forth. In this case, the information of the broadcast program is not limited to the broadcast time, the broadcast date and the program title, but can comprise other information.

A virtual channel processing module 70 updates the information of the broadcast program stored in the database 80. That is, when the program registered in the virtual channel by the user is terminated, the virtual channel processing module 70 controls the terminated program to be removed from the database 80. In addition, when the broadcast time or the broadcast date of the program registered on the virtual channel is changed due via the broadcast station, the virtual channel processing module 70 changes the broadcast time and the broadcast date of the corresponding program already stored in the database 80 to a newly assigned broadcast time or a newly assigned broadcast date. In addition, the virtual channel processing module 70 retrieves the broadcast time from the EPG using the program title selected by the ‘favorite program registration button’ and updates the corresponding program in the database 80 so that the program is broadcast to the user. Accordingly, departing from the conventional retrieval method based on the channel, the user can register the corresponding program on as a favorite program so that every date when the favorite program is broadcast is automatically updated in the database 80.

A user interface 95 displays the virtual channel set by each of the users on a User Interface (UI) screen. The user can determine the virtual channel set by himself and the virtual channel set by another user using a menu on the UI screen.

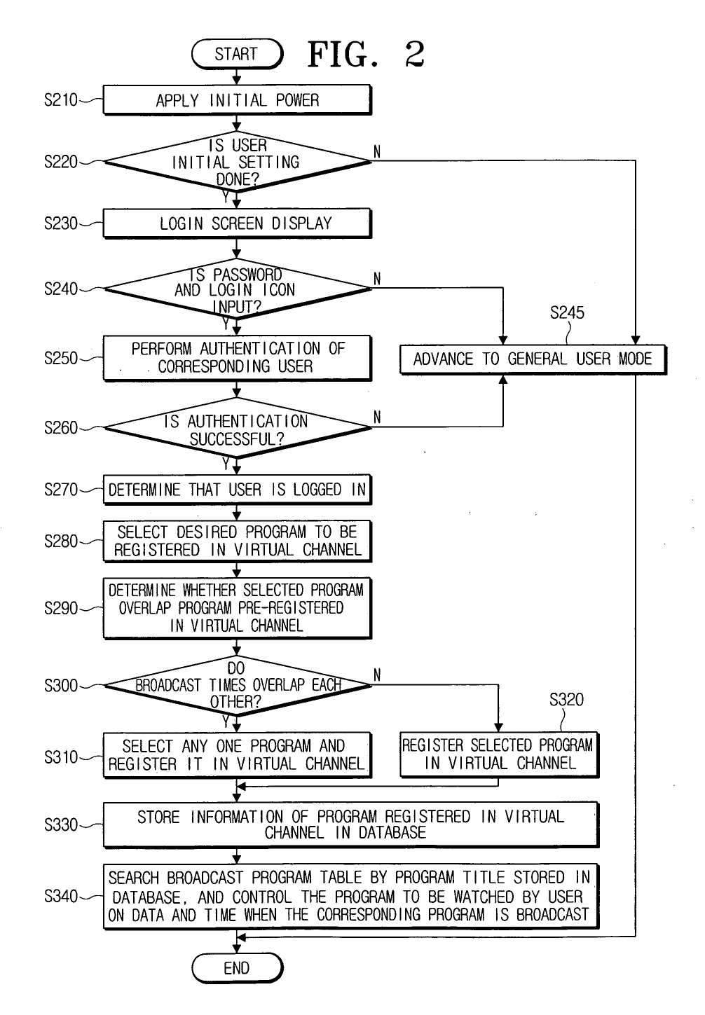

FIG. 2 is a flow chart illustrating a method of operating a virtual channel in accordance with an exemplary embodiment of the present invention. Referring to the flow chart, when initial power is first applied (S210) to the TV watching device 110, the controller 50 determines whether a user initial setting is present (S220).

A procedure for carrying out the user initial setting is as follows. When the user clicks a remote control button (not shown) or a menu button provided on the key input module 90, an initial menu list is displayed on the screen of the user interface 95. A user setting menu is selected among several menus listed on an initial menu list. The user setting menu comprises user registration/deletion/modification options. Among these, the user registration and user modification menus comprise options such as a virtual channel number, a virtual channel title, a login icon, and a password. The user can newly register the virtual channel number, the virtual channel title, the login icon, and the password in the user registration menu to perform the user initial setting, which can be initialized to default values in an unregistered case. In addition, using the user modification menu, the user can change the virtual channel number, the virtual channel title, the login icon, and the password which are already set.

In the step S220, when the user initial setting is present (S220:Yes), a user interface 95 displays a login screen for performing authentication per user (S230). Alternatively, when the user initial setting is not present, a general user mode (S245) can be entered wherein channel or program selection is performed in a conventional manner.

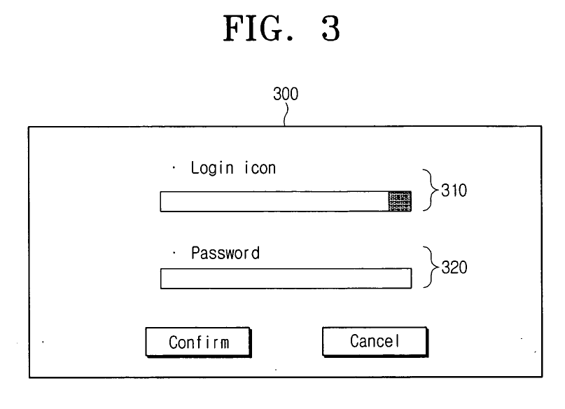

FIG. 3 is a view illustrating a login screen in accordance with an exemplary embodiment of the present invention. Referring to FIG. 3, the login screen 300 is comprised of a login icon input window 310 and a password number input window 320. When the user does not input the password and the login icon (S240:No) but selects ‘Cancel’ on the login screen 300, the general user mode (S245) is entered.

When the user inputs the password and the login icon on the login screen 300 (S240:Yes), the virtual channel setting module 60 performs authentication of the corresponding user (S250).

As a result of the authentication, when the authentication is not successful (S260:No), the general user mode (S245) can be entered. When the authentication is successful (S260:Yes), it is determined that the corresponding user has logged in (S270). In the login state, the user can set his virtual channel number and set a base channel of the virtual channel using the user setting menu. For example, user A can select a SBS channel as the base channel in a channel number CH 111 as his virtual channel, and user B can select an MBC channel as the base channel in a channel number CH 120 as his virtual channel, and then register his favorite channel once he selects it.

As such, when the user tries to register a certain desired program on the virtual channel while watching broadcast programs or tries to register a certain desired program on the virtual channel while seeing the broadcast program listed in a broadcast program organization table, the ‘favorite program registration button’ is used which is a shortcut button provided on the remote control (not shown) or via the key input module 90. That is, the user selects the desired programs to be registered on the virtual channel by pressing the ‘favorite program registration button’ (S280). In this case, the virtual channel processing module 70 determines whether broadcast times of the favorite programs selected by the user overlap broadcast times of the favorite programs which are already registered on the virtual channel (S290).

As a result of the determination, when the broadcast times of the currently registered and newly selected programs overlap each other (S300:Yes), the virtual channel processing module 70 outputs via the user interface 95 a message that a program having the same broadcast time already registered on the virtual channel is present so that the user can select from among the program already registered on the virtual channel and the program desired to be registered on the virtual channel in the current time (S310). Alternatively, when broadcast times of both programs do not overlap each other (S300:No), the user can register his favorite program on his own virtual channel using the above-described manner.

With regard to the steps S310 and S320, when the predetermined program selected by the user is newly registered on the virtual channel, the virtual channel processing module 70 stores the information of the program registered on the virtual channel in the database 80 (S330). In this case, the program information preferably comprises a broadcast time, a broadcast date, a title, and so forth, of the program, however, may comprise other information.

In the meantime, a period during which program information is stored in the database 80 is not limited; however, it is preferable to control the program information to be stored for about one week and then automatically removed or updated.

As such, when the time, date, and title of the program registered on the virtual channel is stored in the database 80, the virtual channel processing module 70 retrieves desired data for a selected program from the broadcast program organization table (e.g., via parsing using a Program & System Information Protocol (PSIP)) by means of the program title stored in the database 80, and controls the program to be registered on the virtual channel set by the user on the date and time when the retrieved program is broadcast as indicated in the table so that it can be watched via the virtual channel (S340).

Accordingly, the user can watch broadcast programs registered on his own virtual channel, that is, TV watching based on programs suited to users' favorites and tastes can be implemented rather than the TV watching based on cumbersome navigation and selection among all the broadcast channels.

Alternatively, when the broadcast period of a program registered on the virtual channel is terminated, the virtual channel processing module 70 can automatically remove it from the program list on the virtual channel. In addition, when the broadcast time or the broadcast date of the program registered on the virtual channel is changed by the broadcast station, the virtual channel processing module 70 retrieves the corresponding data from the broadcast program organization table by the program title and updates the information of the program stored in the database 80 with a newly assigned time or a newly assigned date. In any event, whether the broadcast period of the program registered on the virtual channel is terminated or changed can be obtained by parsing the EPG data stored in the EPG module 40.

According to an exemplary embodiment of the present invention as described above, the virtual channel can be set per user so that a program suited to each user's taste can be watched even when several users use the same TV. Further, the virtual channel can be set per users so that a program best suited to the collective tastes of each of the registered users can be watched when several users simultaneously use the same TV.

Furthermore, according to the present invention, the shortcut button, that is, ‘favorite program registration button’ is provided, so that the user can readily register his favorite programs on the virtual channel with a simple key operation.

Furthermore, according to the present invention, the virtual channel of the user can be updated and the base channel can be changed or added by the program selected by the user. This leads to an advantage which a property that the watching pattern of the user is similar to each date or a property that the user watches the same program during a broadcast period of specific programs can be highly utilized.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An apparatus of generating a virtual channel from a satellite broadcast signal, a cable broadcast signal, or a ground wave broadcast signal received via an antenna or a cable network, the broadcast signal comprising plural channels, comprising:
a virtual channel setting module for setting any one channel among several channels in a broadcast signal as a virtual channel per user; and
a virtual channel processing module for generating at least one program list on a virtual channel comprising one or more a predetermined programs selected by the user who has set the virtual channel and registered in the program list on the virtual channel.

2. The apparatus according to claim 1, wherein a base channel can be set per user for viewing on the virtual channel when no other programs are selected by the user.

3. The apparatus according to claim 1, wherein the virtual channel processing module determines whether broadcast times of the programs selected by the user overlap broadcast times of the programs already registered on the virtual channel, and notifies the user to select one program among the programs registered on the virtual channel to view during respective overlapping broadcast times.

4. The apparatus according to claim 1, further comprising:
a database for storing information corresponding to the program registered on the virtual channel.

5. The apparatus according to claim 4, wherein a period of storing the program information stored in the database is predetermined.

6. The apparatus according to claim 5, wherein the program information comprises a broadcast time, a broadcast date, and a title of the program.

7. The apparatus according to claim 1, wherein the virtual channel processing module retrieves from a broadcast program organization table program information relating to a selected program by its program title, and controls the selected program to broadcast via the virtual channel on the date and time of the broadcast indicated via the retrieved program information.

8. The apparatus according to claim 1, wherein the virtual channel processing module performs a user initial setting on the virtual channel when a virtual channel number, a virtual channel title, a login icon, and a password are newly registered by the user in a predetermined user registration menu.

9. The apparatus according to claim 1, wherein the virtual channel processing module automatically removes the program in the program list on the virtual channel when a broadcast period of the program registered on the virtual channel is terminated.

10. The apparatus according to claim 4, wherein the virtual channel processing module updates the program information corresponding to a program stored in the database with a changed time when the broadcast time of the program registered on the virtual channel is changed.

11. The apparatus according to claim 1, further comprising:
a user interface for displaying the virtual channel set per user on a User Interface (US) screen.

12. The apparatus according to claim 1, further comprising:
a key input module having a shortcut button for registering a program on the virtual channel.

13. A method of operating a virtual channel, comprising:
determining whether a user initial setting for the virtual channel is present;
performing authentication on a user trying to use the virtual channel when the user initial setting for the virtual channel is present;
determining that the user has logged in and setting the virtual channel per user when the authentication for the user is successful; and
registering a predetermined program selected by the user on the virtual channel.

14. The method according to claim 13, further comprising the step of determining whether broadcast times of the programs selected by the user overlap broadcast times of the programs already registered on the virtual channel, and notifying the user to select one program among the programs registered on the virtual channel to view via the virtual channel when the broadcast times overlap one another.

15. The method according to claim 13, wherein information corresponding to the program registered on the virtual channel is stored in a database when the program selected by the user is registered on the virtual channel.

16. The method according to claim 15, wherein the program information comprises a broadcast time, a broadcast date, and a title of the program.

17. The method according to claim 16, further comprises the steps of:
retrieving from a broadcast program organization table program information relating to a selected program by the program title; and
controlling the selected program to be broadcast via the virtual channel on the date and time of broadcast indicated via the retrieved program information.

18. The method according to claim 13, wherein a user initial setting on the virtual channel is completed when a virtual channel number, a virtual channel title, a login icon, and a password are newly registered by the user in a predetermined user registration menu.

19. The method according to claim 16, wherein a program is automatically removed from the program list on the virtual channel when a broadcast period of the program registered on the virtual channel is terminated.

20. The method according to claim 16, further comprising the step of updating the program information with a changed time when the broadcast time of the program registered on the virtual channel is changed.
